(19) United States
(12) Patent Application Publication
(10) Pub. No.: US 2014/0363546 A1
(43) Pub. Date: Dec. 11, 2014

(54) LAMINATES COMPRISING A LOW TEMPERATURE HEAT SEALABLE LAYER CONTAINING POLY(TRIMETHYLENE SUCCINATE) OR POLY(TRIMETHYLENE TEREPHTHALATE-CO-SUCCINATE)

(71) Applicant: E I DU PONT DE NEMOURS AND COMPANY, Wilmington, DE (US)

(72) Inventors: YUXIANG ZHOU, SHANGHAI (CN); XIANG CHEN, SHANGHAI (CN)

(21) Appl. No.: 14/296,499

(22) Filed: Jun. 5, 2014

(30) Foreign Application Priority Data
Jun. 9, 2013 (CN) 201310231716.8

(51) Int. Cl. B65D 85/78; B32B 27/36

(52) U.S. Cl. CPC B65D 85/78; B32B 27/36
USPC 426/130; 428/480; 428/339; 428/423.7; 428/414; 428/483; 428/35.2; 426/106

(57) ABSTRACT

The present invention relates to laminates comprising at least one structural layer and a heat sealable layer, wherein the heat sealable layer comprises or is produced from polytrimethylene succinate, poly(trimethylene terephthalate-co-succinate), or blends thereof. This invention also relates to packages comprising the laminates, said package is heat sealable at a heat sealing temperature below 100° C. to provide a heat sealing strength of 10 N/15 mm or higher.

### FIELD OF THE INVENTION

This present invention relates to laminates comprising a low temperature heat sealable layer containing polytrimethylene succinate or poly(trimethylene terephthalate-co-succinate) and to packages comprising said laminates.

### BACKGROUND OF THE INVENTION

With the dwindling of the fossil fuels and the increasing concerns of the environment, the developing of new feedstock of renewably sourced and/or biodegradable polymeric materials are drawing more and more attention. Particularly, concern is for packaging applications where the usage of polymeric materials is tremendous and the packages are usually disposed of after consuming the contained foodstuffs. Therefore, the development of biodegradable packaging materials is desirable.

Biodegradable materials suitable for use as packages must meet the strength, clarity, barrier qualities and/or can be optimally sealed. The optimum seal of a package refers to one that meets the physical configuration that is required for the specific applications, meets or exceeds the strength requirements, and is uniform, attractive, and free of defects or deformation. Packages such as bags sealed with adhesive are generally not as strong in the seal area as heat sealable packages. A heat sealable package generally contains multiple functional layers including at least one structural layer and a heat sealable layer. To obtain optimum seal of the heat sealable package, the melting temperature of the structural layer must be sufficiently higher than that of the heat sealable layer to provide an uniform seal, which generally is at least 20° C. higher.

To date, many biodegradable polymers are known and can be classified into the following categories: 1) aliphatic polyesters such as polybutylene succinate, polybutylene succinate-co-adipate, polylactic acid, polycarprolactone, or blends thereof; 2) aliphatic aromatic copolyesters such as polybutylene adipate-co-terephthalate; 3) blends of aliphatic polyesters and aliphatic aromatic copolyesters.

It is desirable to obtain a polymeric material that is heat sealable at a relatively low temperature (i.e. about 100° C. or lower) for packaging food products that are sensitive to high temperatures (e.g., chocolate, cheese, etc.). It is highly desirable that the low temperature heat sealable material is also biodegradable since many biodegradable polymers described above have melting temperatures (Tₘ) generally above 100° C.

EP Patent Application Publication No. 1348541 discloses a method of using Ecoflex®, a biodegradable copolyester of polybutylene adipate-co-terephthalate commercially available from BASF, as a heat sealable layer and with a heat sealing temperature at 100° C. or lower. However, the resulted heat sealing strength of the heat sealed product was below 7 N/15 mm, which didn't meet the seal strength requirement.

JP Patent Application Publication No. 2005-280797 discloses a biodegradable material for a packaging application comprising an aliphatic aromatic copolyester and a modified polyethylene terephthalate. Due to the high melting temperatures of the aliphatic aromatic copolyester and the modified polyethylene terephthalate (115° C. and 199° C., respectively), the disclosed material had to be heat sealed at 190° C.

JP Patent Application Publication No. 03-097556 discloses a laminate comprising aliphatic aromatic copolyesters for retortable packaging application. The disclosed copolyesters have a melting temperature higher than 125° C., and therefore were not suitable for packaging application requires to heat seal at 100° C. or below.

Therefore, it is desirable to develop a polymeric material that is low temperature heat sealable (i.e. about 100° C. or lower) for packaging food products that are sensitive to high temperatures (e.g., chocolate, cheese, etc.). It is preferable that the low temperature heat sealable material is also biodegradable. The polymeric material can then be used in combination with the above mentioned known biodegradable polymers, e.g., polylactic acid. Although most of known polymers have a melting temperature (Tₘ) above 100° C., they become deformed or wrinkle easily when the heat sealing temperature is about 100° C. or higher.

### SUMMARY OF THE INVENTION

This invention provides a laminate comprising (A) at least one structural layer and (B) a heat sealable layer having a melting temperature below 100° C., wherein

the structural layer comprises a paper sheet, an aluminum foil, a polymeric film, a metallized polymeric film, or combinations thereof;

the heat sealable layer comprises or is produced from polytrimethylene succinate, poly(trimethylene terephthalate-co-succinate), or blends thereof; and

provided that when the structural layer is a polymeric film, the melting temperature (Tₘ) of the polymeric film is above 100° C.

In one embodiment, in the laminate of the present invention, the polytrimethylene succinate is consisting of repeating units derived from monomers comprising:
(a) about 100 mol % of 1,3-propanediol; and
(b) about 100 mol % of succinate, and anhydride, salt or ester thereof.

In another embodiment, in the laminate of the present invention, wherein the poly(trimethylene terephthalate-co-succinate) is consisting of repeating units derived from monomers comprising:
(a) about 100 mol % of 1,3-propanediol;
(b) about 65-99 mol % of succinate, and anhydride, salt or ester thereof; and
(c) about 1-35 mol % of terephthalate, and salt or ester thereof.

In one embodiment, in the laminate of the present invention, wherein the polytrimethylene succinate or the poly(trimethylene terephthalate-co-succinate) has a number average molecular weight (Mₙ) of from about 12,000 to about 100,000.

In one embodiment, in the laminate of the present invention, the structural layer is a polymeric film selected from the group consisting of polylactic acid (PLA), polycaprolactone (PCL), poly(3-hydroxybutyrate), poly(3-hydroxyvalerate), poly(3-hydroxybutyrate-co-3-hydroxyvalerate), polybutylene succinate, polyethylene terephthalate (PET), polybutylene terephthalate (PBT), polyethylene naphthalate, polyamide 6, polyamide 66, poly(m-xylene adipamide), polypropylene (PP), polyethylene (PE), maleic anhydride grafted polyethylene, maleic anhydride grafted polypropylene, ethylene-vinyl acetate copolymer (EVA), ethylene-(meth)acrylic acid copolymer, partially neutralized ethylene-(meth)acrylic acid copolymer, ethylene-vinyl alcohol copolymer (EVOH), polyvinyl alcohol (PVOH), polyvinyl chloride (PVC), polyvinylidene chloride (PVDC), polychlorotrifluoroethylene (PCTFE), and blends thereof.

In another embodiment, in the laminate of the present invention, the structural layer is a metallized polymeric film selected from aluminized polyethylene terephthalate and aluminized polypropylene.

In one embodiment, in the laminate of the present invention, the total thickness of the structural layer is about 5 μm to about 200 μm, and the thickness of the heat sealable layer is about 5 μm to about 100 μm.

In one embodiment, the laminate of the present invention is produced by a method selected from dry lamination, extrusion lamination, extrusion coating, co-extrusion casting, and co-extrusion film blowing.

In another embodiment, the laminate of the present invention further comprises an adhesive layer (C1) that is between the structural layer and the heat sealable layer, wherein the adhesive layer comprises or is produced from polyurethane, epoxy, polyacrylate, or mixtures thereof.

In yet another embodiment, the laminate of the present invention further comprises a tie layer (C2) that is between the structural layer and the heat sealable layer, wherein the tie layer comprises or is produced from ethylene vinyl acetate copolymer, maleic anhydride grafted polyethylene/polypropylene, ethylene-(meth)acrylic acid copolymers, partially neutralized ethylene-(meth)acrylic acid copolymers, or blends thereof.

This invention also provides a package comprising or produced from the laminate of the present invention, wherein the heat sealable layer is the innermost layer of the package, and the package is heat sealable at a heat sealing temperature below 100° C. to provide a heat sealing strength of 10 N/15 mm or higher as measured according to the method of ASTM F88/F88M-09.

In one embodiment, the package of the present invention is a bag, a pouch, a cup lid, or a tray cover.

In one embodiment, the package of the present invention further comprises a contained foodstuff.

In another embodiment, in the package of the present invention, the contained foodstuff is cheese, chocolate, or ice-cream.

Various other features, aspects, and advantages of the present invention will become more apparent with reference to the following description, examples, and appended claims.

### DETAILS OF THE INVENTION

All publications, patent applications, patents and other references mentioned herein, if not otherwise indicated, are explicitly incorporated by reference herein in their entirety for all purposes as if fully set forth.

Unless otherwise defined, all technical and scientific terms used herein have the same meaning as commonly understood by one of ordinary skill in the art to which this invention belongs. In case of conflict, the present specification, including definitions, will control.

As used herein, the term “produced from” is synonymous to “comprising”. As used herein, the terms “comprises,” “comprising,” “includes,” “including,” “has,” “having,” “contains” or “containing,” or any other variation thereof, are intended to cover a non-exclusive inclusion. For example, a composition, process, method, article, or apparatus that comprises a list of elements is not necessarily limited to only those elements but may include other elements not expressly listed or inherent to such composition, process, method, article, or apparatus.

The transitional phrase “consisting of” excludes any element, step, or ingredient not specified. If in the claim, such a phrase would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition, method or apparatus that includes materials, steps, features, components, or elements, in addition to those literally discussed, provided that these additional materials, steps features, components, or elements do not materially affect the basic and novel characteristic(s) of the claimed invention. The term “consisting essentially of” occupies a middle ground between “comprising” and “consisting of”.

The term “comprising” is intended to include embodiments encompassed by the terms “consisting essentially of” and “consisting of”. Similarly, the term “consisting essentially of” is intended to include embodiments encompassed by the term “consisting of”.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. For example, when a range of “1 to 5” is recited, the recited range should be construed as including ranges “1 to 4”, “1 to 3”, “1-2”, “1-2 & 4-5”, “1-3 & 5”, and the like. Where a range of numerical values is recited herein, unless otherwise stated, the range is intended to include the endpoints thereof, and all integers and fractions within the range.

When the term “about” is used in describing a value or an end-point of a range, the disclosure should be understood to include the specific value or end-point referred to.

Further, unless expressly stated to the contrary, “or” refers to an inclusive “or” and not to an exclusive “or”. For example, a condition A “or” B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

“mol %” or “mole %” refers to mole percent.

In describing and/or claiming this invention, the term “homopolymer” refers to a polymer derived from polymerization of one species of repeating unit. As used herein, the term “copolymer” refers to polymers comprising copolymerized units resulting from copolymerization of two or more comonomers. “Dipolymer” refers to polymers consisting essentially of two comonomer-derived units and “terpolymer” means a copolymer consisting essentially of three comonomer-derived units.

In describing certain polymers it should be understood that sometimes applicants are referring to the polymers by the monomers used to produce them or the amounts of the monomers used to produce the polymers. While such a description may not include the specific nomenclature used to describe the final polymer or may not contain product-by-process terminology, any such reference to monomers and amounts should be interpreted to mean that the polymer comprises those monomers (i.e. copolymerized units of those monomers) or that amount of the monomers, and the corresponding polymers and compositions thereof.

Embodiments of the present invention as described in the Summary of the Invention include any other embodiments described herein, can be combined in any manner, and the descriptions of variables in the embodiments pertain not only to the laminates of the present invention, but also to the packages made therefrom.

The materials, methods, and examples herein are illustrative only and, except as specifically stated, are not intended to be limiting. Although methods and materials similar or equivalent to those described herein can be used in the practice or testing of the present invention, suitable methods and materials are described herein.

The invention is described in detail hereinunder.

### Components of the Laminate

### (A) Structural Layer

According to the present invention, the structural layer of the laminate is the main component for packing applications. Depending on the packaging need and intended condition of use, the structural layer can be bonded or adhesively laminated to the heat sealable layer and other materials to enhance performance of the overall structure.

Examples of materials useful as the structural layer of the present laminate include paper sheets, aluminum foils, polymeric films, metallized polymeric films, or combinations thereof.

This layer preferably is unaffected by the heat sealing temperatures used to make the package, since the package is heat sealed through the entire thickness of the laminate. The structural layer may be provided with graphic elements such as printing and embossing to provide information for the consumer and/or a pleasing appearance to the package. Preferably this layer is reverse printable. The particular multi-layered film used will in part depend upon the end use of the package. For example, packages containing bones or other hard projections will require thicker structural layers. The thickness of the structural layer will also depend on the depth of the draw desired during thermoforming.

The thickness of the structural layer can control the stiffness of the package, and may range from about 5 μm to about 200 μm. When a single layer of a certain material is not thick or stiff enough, multiple layers of the same material or combinations with other materials may be employed. For example, a single layer of an aluminum foil having a thickness of about 5 μm to about 15 μm may provide sufficient stiffness; whereas a polymeric film of the same thickness may be used in combination with a paper sheet to provide the same stiffness.

In one embodiment, in the laminate of the present invention, the total thickness of the structural layer is about 5 μm to about 200 μm.

In one embodiment, in the laminate of the present invention, the structural layer is a paper sheet having a basis weight ranging from 30 to 300 g/m².

In another embodiment, in the laminate of the present invention, the structural layer is an aluminum foil having a thickness of about 5 μm to about 15 μm.

In yet another embodiment, in the laminate of the present invention, the structural layer is a polymeric film or a metallized polymeric film.

Polymeric films suitable for use as the structural layer of the present laminate comprises or is produced from the group consisting of polylactic acid (PLA), polycaprolactone (PCL), poly(3-hydroxybutyrate), poly(3-hydroxyvalerate), poly(3-hydroxybutyrate-co-3-hydroxyvalerate), polybutylene succinate, polyethylene terephthalate (PET), polybutylene terephthalate (PBT), polyethylene naphthalate; polyamide 6, polyamide 66, poly(m-xylene adipamide), polypropylene (PP), polyethylene (PE), maleic anhydride grafted polyethylene, maleic anhydride grafted polypropylene, ethylene-vinyl acetate copolymer (EVA), ethylene-(meth)acrylic acid copolymer, partially neutralized ethylene-(meth)acrylic acid copolymer, ethylene-vinyl alcohol copolymer (EVOH), polyvinyl alcohol (PVOH), polyvinyl chloride (PVC), polyvinylidene chloride (PVDC), and polychlorotrifluoroethylene (PCTFE), and blends thereof.

Metallized polymeric films suitable for use as the structural layer of the present laminate include, for example, aluminized polyethylene terephthalate (Al-PET) and aluminized polypropylene (Al-PP).

Polymeric films or metallized polymeric films suitable for use as the structural layer of the present laminate generally have a thickness of from about 5 μm to about 200 μm; preferably, from about 10 μm to about 100 μm; and more preferably, from about 20 μm to about 50 μm.

In one embodiment, in the laminate of the present invention, the structural layer is a polymeric film or a metallized polymeric film with the thickness from about 5 μm to about 200 μm; or from about 10 μm to about 100 μm; or from about 20 μm to about 50 μm.

The polymeric film described herein can be obtained commercially. For example, PLA films are available from Nantong GuRun Biological Co., Ltd.

PET films are available from Jiangsu Euro-Asia Film Co., Ltd.; oriented polyester films such as Mylar® and Melinex® are available from DuPont Teijin Films.

Polyoelfins such as LLDPE LL 1002YB are available from Exxon Mobil Corporation.

Polyamide 6,6 is commercially available under the tradename Akulon®S240-C from DSM. polyamide 6 is available under the tradename Capron® from Honeywell International.

EVA copolymer such as Elvax® are available from E.I. du Pont de Nemours and Company, Wilmington, Del. USA. (referred as DuPont hereunder).

EVOH copolymers such as EVAL® are available from Kuraray Co. Ltd.; or under the tradename Soarnol® from Nippon Goshei, for example Polyvinylidene chloride (PVDC) suitable for use herein can be obtained commercially from Dow Chemical under the tradename Saran®, for example.

Aluminized polyethylene terephthalate and aluminized polypropylene films suitable for use herein can be obtained commercially from Anhui Tonda Packing Materials Co., LTD.

### (B) Heat Sealable Layer

According to the present invention, the heat sealable layer comprises or is produced from polytrimethylene succinate (PTS), poly(trimethylene terephthalate-co-succinate) (PTT-PTS), or blends thereof.

Generally, PTS (i.e. a homopolymer) or PTT-PTS (i.e. a random copolymer) can be prepared by condensation polymerization of 1,3-propanediol, succinic acid, and/or terephthalic acid. The succinic acid and the 1,3-propanediol used in the invention are preferably obtained biochemically from a renewable source such as but not limited to corn starch. Methods for preparing PTS or PTT-PTS are well known in the art. For reference, e.g., Papageorgiou, G. Z. et al., Macromolecules 2008, 41, 1675-1684.

The melting temperature of PTT-PTS can be tailored by adjusting the molar ratio between the succinate units and the terephthalate units. As the molar ratio of the terephthalate units in PTT-PTS increases, the melting temperature of the resulting PTT-PTS increases. For example, melting temperature of PTS is about 46° C., whereas PTT-PTS, having 30 mol % of terephthalate units, has a melting temperature of about 77° C. Therefore, to ensure the heat sealable layer of the present laminate can be optimally heat sealed at a temperature below 100° C., the melting temperatures of PTT-PTS is generally lower than 100° C.; preferably, lower than 90° C.; more preferably, lower than 80° C.

Accordingly, suitable PTT-PTS for use as the heat sealable layer of the present laminate may have a the molar fraction of the terephthalate units in PTT-PTS is about 1% to about 35%; or about 5% to about 30%; or about 10% to about 20%. In other words, the molar fraction of the succinate units in PTT-PTS is about 65% to about 99%; or about 70% to about 95%; or about 80% to about 90%.

In one embodiment, the heat sealable layer comprises PTS or PTT-PTS, or is produced from PTS or PTT-PTS, consisting of repeating units derived from monomers comprising:

(a) about 100 mol % of 1,3-propanediol;

(b) about 65-100 mol % of succinate, and anhydride, salt or ester thereof; and

(c) about 0-35 mol % of terephthalate, and salt or ester thereof.

The objective of the present invention is to keep a good balance of a low heat sealing temperature and a high heat sealing strength, suitable PTS or PTT-PTS for use as the heat sealable layer of the present laminate has a number average molecular weight (Mₙ) ranging from about 12,000 to about 100,000; or from about 20,000 to about 85,000; or from about 40,000 to about 70,000 as determined by gel permeation chromatography (GPC). The molecular weight of the PTS homopolymer or the PTT-PTS copolymer may increase by lengthening the polycondensation time during their preparation. When the number average molecular weight of PTS or PTT-PTS is lower than 12,000, a lower heat seal strength is expected due to the weaker mechanical properties of the polymers. However, when the number average molecular weight of PTS or PTT-PTS is higher than 100,000, the production time of the polymers can be too long and may also bring processing difficulties.

The heat sealable layer in the present invention typically is a film having a thickness of from about 5 μm to about 100 μm; or from about 10 μm to about 50 μm. As such, the PTS polyester or PTT-PTS copolyester can be made into a film by virtually any methods known to one skilled in this art, such as solution coating, melt casting, extruding, and the like.

In one embodiment, in the laminate of the present invention, the heat sealable layer is a film produced by solution coating.

PTS polyester or PTT-PTS copolyester can be dissolved in a solvent (e.g., tetrahydrofuran) and subsequently coated on a base film that is chemically inert to the solvent (e.g., a polyethylene film) to form a wet film; after evaporation of the solvent, then removal of the base film to provide a dry film comprising PTS or PTT-PTS.

### (C1) Adhesive Layer

The laminate of the present invention may further comprise an adhesive layer (C1) that is between the structural layer and the heat sealable layer. Particularly, the laminate is produced by dry lamination of the respective films constituting the structural layer and the heat sealable layer.

The adhesive layer suitable for use in the present invention comprises or is produced from polyurethane, epoxy, polyacrylate, or mixtures thereof. One skilled in the art can select the appropriate adhesive layer based on the materials actually used in the present laminates.

In one embodiment in the laminate of the present invention, the adhesive layer comprises polyurethane.

The adhesive layer described herein can be obtained commercially. For example, polyurethane adhesive under the tradename of Liofol® UK 3640/UK 6800 system or Liofol® UR 2860/UK 5000 system are available from Henkel; or Tiemao® 101 series from Shanghai Xinguang Chemical Co. Ltd.

### (C2) Tie Layer

The laminate of the present invention may comprise a tie layer (C2) that is between the structural layer and the heat sealable layer. Particularly, the laminate is produced by extrusion lamination or extrusion coating. A “tie” layer refers to polymeric materials that can be used as extrudable adhesives to improve the bonding between the structural layer and the heat sealable layer. One skilled in the art can select the appropriate tie layer based on the materials actually used in the present laminates.

The tie layer suitable for use in the present invention comprises or is produced from ethylene-vinyl acetate copolymer, maleic anhydride grafted polyethylene, maleic anhydride grafted polypropylene, ethylene-(meth)acrylic acid copolymer, partially neutralized ethylene-(meth)acrylic acid copolymer, or mixture thereof.

Various tie layer compositions described herein can be obtained commercially, for example, Bynel® from DuPont.

### Process of Manufacturing the Laminate

The laminate of the present invention can be manufactured by known methods including but not limited to dry lamination, extrusion lamination, extrusion coating, co-extrusion casting, or co-extrusion blown film. Preferably, the laminate is manufactured by dry lamination.

When the structural layer and the heat sealable layer both are in the form of film, foil, and/or sheet, dry lamination by adhering the heat sealable layer to the structural layer with the aid of a suitable adhesive is the method of choice. Extrusion lamination by extruding a tie layer between the heat sealable layer and the structural layer to form the laminate is another option.

Alternatively, the laminate of the present invention may be produced by extruding pellets of PTS, PTT-PTS, or blends thereof to form the heat sealable layer onto the structural layer (i.e. extrusion coating); wherein if needed a tie layer can be extruded between the heat sealable layer and the structural layer to improve bonding (i.e. extrusion lamination).

Additionally, the laminate can be produced in one step by co-extrusion casting or co-extrusion film blowing, wherein the structural layer is extruded from the pellets of the aforementioned polymers and the heat sealable layer is extruded from the pellets of PTS, PTT-PTS, or blends thereof.

Packages Comprising or Produced from the Laminate

The heat sealable layer of the present laminates can be heat sealed at a temperature below 100° C. with high heat sealing strength, which is 10 N/15 mm or higher as measured according to the method of ASTM F88/F88M-09. Therefore, the laminates of the present invention are useful in fabrication of heat sealable bags and thermoformable structures for packaging any variety of products in addition to the foodstuffs enumerated herein.

Examples of the packages include bags, pouches, cup lids, or tray covers, wherein the heat sealable layer is the innermost layer.

Packages described herein may be used to package products such as yogurts, puddings, custards, gelatins, fruit sauces (for example, applesauce) and the like. They may also be used to package ice cream, chocolate and cheese spreads or dips.

Packages described herein may also be used to package meats and frozen or refrigerated meals.

Packages of this invention may also be used to package dry foods such as noodles and seasoning for reconstitution with water. They can also be used to package dry snacks such as cookies, chips and the like.

Without further elaboration, it is believed that one skilled in the art using the preceding description can utilize the present invention to its fullest extent. The following Examples are, therefore, to be construed as merely illustrative, and not limiting of the disclosure in any way whatsoever.

### EXAMPLES

The abbreviation “E” stands for “Example” and “CE” stands for “Comparative Example” is followed by a number indicating in which example PTS homopolymer or PTT-PTS copolymers is synthesized, or the laminate is prepared. The examples and comparative examples were all prepared and tested in a similar manner. Percentages are based by mole unless otherwise indicated.

In the examples that follow, the following materials were used:

### Materials

PDO: 1,3-propanediol, CAS number: 504-63-2, obtained from DuPont.

SA: Succinic acid, CAS number: 110-15-6, purchased from Sinopharm Chemical Reagent Co., Ltd.

TPA: Terephthalic acid, CAS number: 100-21-0, purchased from Sinopharm Chemical Reagent Co., Ltd.

TPT: Titanium (IV) isopropoxide, CAS number: 546-68-9, purchased from Tokyo Chemical Industry Co., Ltd. under the trade name of Tyzor®.

TPP: Triphenylphosphate, CAS number: 115-86-6, purchased from Tokyo Chemical Industry Co., Ltd.

Ecoflex®: F Blend C1200, an aliphatic aromatic copolyester of polybutylene terephthalate-co-adipate, Tₘ: 110˜120° C., purchased from BASF.

PLA film: a polylactic acid film with a thickness of 30 μm, Tₘ: 151° C., purchased from Nantong GuRun Biological Co., Ltd.

PET film: a clear biaxially oriented PET film with a thickness of 25 μm, Tₘ: 260° C., purchased from Jiangsu Euro-Asia Film Co., Ltd.

Polyurethane adhesive: Liofol® UR 2860/UK 5000 purchased from Henkel.

### Test Methods

¹H Nuclear Magnetic Resonance Spectroscopy (NMR): ¹H NMR spectra were obtained on a Bruker 400 MHz Advance II spectrometer, using deuterated chloroform as a solvent. The chemical shifts of the protons were reported in δ values downfield from the internal standard-tetramethylsilane (TMS).

For PTS homopolymer: 1.98 (2H, —OCH₂CH₂CH₂O—), 2.63 (4H, —COCH₂CH₂CO—), 4.20 (4H, —OCH₂CH₂CH₂O—).

For PTT-PTS random copolymer: 1.95-2.31 (2H, —OCH₂CH₂CH₂O—), 2.63 (4H, —COCH₂CH₂CO—), 4.16-4.56 (4H, —OCH₂CH₂CH₂O—), 8.10 (4H, —COC₆H₄CO—).

The actual molar ratios of terephthalate units and succinate units in PTT-PTS were then calculated by integrations of the absorption peaks at the characteristic chemical shifts for the aromatic protons in the terephthalate units δ8.10) and the —COCH₂CH₂CO— group in the succinate units (δ2.63).

Differential Scanning calorimetry (DSC): Melting temperature and glass transition temperature were determined by using a TA Q100 differential scanning calorimeter under a nitrogen atmosphere. The sample was first heated from room temperature to 250° C. at a rate of 20° C./min, during which the melting temperature (Tₘ) was recorded. Subsequently, the sample was cooled down to −70° C. at a rate of 20° C./min, during which the glass transition temperature (T_{g}) was recorded.

Gel Permeation Chromatography (GPC): The number average molecular weights (Mn) and the polydispersity indices (PDI) of the synthesized PTS homopolymer and PTT-PTS copolymers were measured on a Waters eAlliance 2695/2414 with RI detector using tetrahydrofuran as the eluent (35˜45° C., flow rate was 1 mL/min) and polystyrene as the standards.

Intrinsic viscosity (IV): The synthesized polymer was dissolved in a mixed solvent of phenol/tetrachloroethane (60/40, w/w), and was kept at 92° C. in a shaker for 1 hour to ensure the fully dissolution of the polymer. The solution was then cooled down to room temperature and transferred into an Ubbelohde viscometer. The viscometer was kept in the constant temperature bath at 30° C. for 25 min followed by recording the efflux time. Three parallel trials were tested and the intrinsic viscosity was calculated from the average efflux time.

Examples 1-7 describe the preparation of PTS homopolymer and/or PTT-PTS random copolymers, and the use of which as the heat sealable layer for the laminates prepared in Examples 8-13.

### Example 1

### Step A: Esterification

PTS homopolymer was synthesized using a condensation polymerization method. 1,3-propanediol, succinic acid with a molar ratio of 1.8:1, and triphenylphosphate (TPP, 300 ppm with respect to the theoretical mass of the polymeric products) were charged to a 500 mL round bottom flask, fitted with an overhead stirrer, a distillation condenser and a bubbler. The reaction mixture were purged with a slow stream of nitrogen gas (1˜2 bubbles/s) for 30 min. Subsequently, the catalyst titanium(IV) isopropoxide (TPT, 150 ppm with respect to the theoretical mass of the polymeric products) was added. The reaction flask was kept under a nitrogen atmosphere and immersed into a preheated metal bath set at 160° C. The reactants were allowed to equilibrate with stirring at 160° C. for 20 min; after which the bath temperature was increased to 180° C. The esterification reaction was allowed to proceed for 5 hours to remove water, and the reaction mixture became a clear melt.

### Step B: Polycondensation

Subsequently, the metal bath temperature was increased to 230° C., and the reaction system was connected to a vacuum pump to reach a pressure of ˜10⁻² mbar in 1.5 hours and held for another 6 hours to remove 1,3-propanediol and water. Finally, the metal bath was removed and the reaction mixture was allowed to cool to room temperature. The PTS homopolymers were isolated and characterized by ¹H NMR, DSC, and GPC. The results were listed in Table 1.

### Example 2

PTS homopolymer was prepared by procedures similar to what was described in Example 1, except that in the polycondensation step, after the vacuum reached 10⁻² mbar, the reaction was only held for 3 hours. The PTS homopolymers were isolated and characterized by ¹H NMR, DSC, and GPC. The results were listed in Table 1.

### Examples 3-6

### Step A: Esterification

PTT-PTS random copolymers with varied succinate and terephthalate molar ratios were synthesized using the condensation polymerization method similar to E1 with minor changes. Succinic acid, terephthalic acid, 1,3-propanediol with a specified molar ratio listed in Table 1, and TPP (300 ppm with respect to the theoretical mass of the polymeric products) were charged to a pre-dried 500 mL round bottom flask, fitted with an overhead stirrer, a distillation condenser and a bubbler. The reaction mixture was purged with a slow stream of nitrogen gas for 30 min. Subsequently, the catalyst TPT (150 ppm with respect of the theoretical mass of the polymeric products) was added. The reaction flask was kept under a nitrogen atmosphere and immersed into a preheated metal bath set at 160° C. The reactants were allowed to equilibrate with stirring at 160° C. for 20 min; after which the bath temperature was increased to 180° C. Water started to distill and condense in the receiver. The esterification reaction was allowed to proceed for 2 hours. The temperature was then increased to 210° C. and held for 1 hour. The bath temperature was further increased to 230° C. and held for another 1 hour until the reaction mixture became fully clear.

### Step B: Polycondensation

The system was connected to the vacuum pump and maintained the bath temperature at 230° C. The vacuum was slowly reduced to ˜10⁻² mbar in a period of 1.5 hours. After that, the reaction mixture was held at 230° C. for 6 hours. The reaction mixture became very viscous. Finally, the metal bath was removed and the reaction mixture was allowed to cool to room temperature. The PTT-PTS random copolymers were isolated and characterized by ¹H NMR, DSC, and GPC. The results were listed in Table 1.

### Example 7

PTT-PTS random copolymer with a molar ratio of terephthalic acid:succinic acid:1,3-propanediol equal to 0.3/0.7/1.8 was synthesized using the procedures described in E3-E6, except that in the polycondensation step, after the vacuum reached 10⁻² mbar, the reaction was only held for 3 hours. The resulting PTT-PTS random copolymers were isolated and characterized. The results were listed in Table 1.

TABLE 1

| | Sample No. | | | | | | |
|---|---|---|---|---|---|---|---|
| Materials | E1 | E2 | E3 | E4 | E5 | E6 | E7 |
| molar ratio of diacid | PTS | | PTT-PTS | | | | |
| monomer | homopolymer | | random copolymer | | | | |
| TPA | 0 | 0 | 0.05 | 0.1 | 0.2 | 0.3 | 0.3 |
| SA | 1 | 1 | 0.95 | 0.9 | 0.8 | 0.7 | 0.7 |
| Polycondensation time (hour) | 6 | 3 | >6 | >6 | 6 | 6 | 3 |
| PTS mol % (theoretical) | 100 | 100 | 95 | 90 | 80 | 70 | 70 |
| PTS mol % (measured)* | 100 | 100 | 94.7 | 88.6 | 78.0 | 69.2 | 69.3 |
| Mₙ | 49,283 | 15,319 | 54,407 | 64,846 | 62,134 | 46,443 | 25,389 |
| PDI | 3.57 | 1.80 | 2.97 | 1.82 | 1.91 | 2.06 | 1.77 |
| T_{g} (° C.) | −27.3 | — | −24.0 | −20.8 | −14.6 | −12.2 | −11.9 |
| Tₘ (° C.)/ | 45.7 | — | 44.0 | — | 50.4 | 77.0 | 72.8 |
| ΔH (J/g) | (21.7) | | (10.6) | | (14.3) | (22.1) | (24.9) |
| IV (dL/g) | 1.49 | 0.52 | 1.67 | 2.12 | 1.64 | 1.44 | 0.77 |

*The actual mol % of the succinate units in PTT-PTS was measured and calculated by ¹H NMR.

The PTS homopolymers and PTT-PTS copolymers prepared in Examples 1-7 were used as the heat sealable layers of the laminates prepared in Examples 8-13. General procedures for preparation of the laminates are described below.

### General Procedure for Preparation of the Laminates of E8-E13 and CE1-CE2

### Step A: Preparation of the Heat Sealable Film

The PTS or PTT-PTS prepared in one of the examples 1-7 as indicated in Table 2 was dissolved in about 100 mL of tetrahydrofuran to give a solution with a solid content of about 20%. The resulting solution was then applied on a polyethylene base film (about 30 cm×about 50 cm in size) using a Meyer rod to make a film having a wet thickness of 100 μm. The wet film was dried in the air at room temperature for 48 hours to yield a dry film of about 20 μm in thickness, which was used for the heat sealable layer (B) of the present laminate.

Step B 1: Laminating with PET Film as the Structural Layer (A) by Dry Lamination

The film obtained from Step A (i.e. as the heat sealable layer (B)) was laminated to a PET film (i.e. as the structural layer (A)) by a dry lamination method with the aid of a polyurethane adhesive (Liofol® UR 2860/UK 5000 purchased from Henkel) to provide a laminate of the present invention.

To ensure good bonding between the PET film and the polyurethane adhesive, the PET film was first subjected to a corona treatment. The polyurethane adhesive dispersed in ethyl acetate was applied to the corona treated surface of the PET film using a Meyer rod to make an adhesive layer having a wet thickness of 30 μm. The adhesive coated PET film was left for drying about 5 min to allow most of the ethyl acetate to evaporate. Afterwards, the heat sealable film obtained from Step A was laminated to the adhesive coated PET film using a hot roll laminator (manufactured by ChemInstruments, Inc., US).

Step B2: Laminating with PLA Film as the Structural Layer (A) by Dry Lamination

The film obtained from Step A (i.e. as the heat sealable layer (B)) was laminated to a PLA film (i.e. as the structural layer (A)) by a dry lamination method with the aid of a polyurethane adhesive.

To ensure good bonding between the PLA film and the polyurethane adhesive, the PLA film was subjected to a corona treatment. Because PLA film would swell in ethyl acetate, the adhesive dispersed in ethyl acetate was applied to the film obtained from Step A using a Meyer rod to form an adhesive layer having a wet thickness of 30 μm. The adhesive coated film was left for drying about 5 min to allow most of the ethyl acetate to evaporate, followed by being laminated to the corona treated PLA film using a hot roll laminator.

### Test Method for the Laminates of E8-E13 and CE1-CE2

Each of the prepared laminates of E8-E13 and CE1-CE2 in a square shape was cut to a rectangle piece of 20 cm in length and 15 cm in width. The rectangle laminate was then folded from the midline along the length direction, with the heat sealable layer facing inside and heat sealed at a set temperature for 1 second and a pressure of 40 psi on a crimp sealer, manufactured by Lako Tool, model SL-2. The resulting heat sealed laminate has the heat seal line about 6 cm from the opening end, and the width of the heat sealed area is 2.54 cm.

The heat sealed rectangle laminate was cut along the length direction into 5 sample strips of 2.5 cm in width. The heat seal strength was measured using an Instron 5567 (Instron Corporation, US) at a tensile speed of 30 cm/min at room temperature according to ASTM F88/F88M-09. The maximum peel strength at which the heat sealed area was peeled open or broken was referred as the heat seal strength, in unit of N/15 mm. The test was repeated 5 times in total, and the averaged value of the heat seal strength data was reported and listed in Table 2.

The appearance of the heat sealed area of the laminate was evaluated visually. The samples having a clean and smooth heat sealed area were indicated by “◯”, and those having a corrugated or distorted heat sealed area were indicated by “×”. The appearance evaluation results are listed in Table 2.

TABLE 2

| | Laminate No. | | | | | | | |
|---|---|---|---|---|---|---|---|---|
| | CE1 | E8 | E9 | E10 | E11 | E12 | CE2 | E13 |
| Material for the heat sealable layer | Ecoflex ® | E1 | E3 | E4 | E5 | E6 | Ecoflex ® | E5 |
| (B) | | | | | | | | |
| PTS mol % of the polyester or | — | 100 | 95 | 90 | 80 | 70 | — | 80 |
| copolyester film | | | | | | | | |
| Tₘ (° C.) of polyester or copolyester | 110-120 | 45.7 | 44.0 | NA | 50.4 | 77.0 | 110-120 | 50.4 |
| Material for the structural layer | PET | PET | PET | PET | PET | PET | PLA | PLA |
| (A) | | | | | | | | |

Laminates Evaluation

| | | Laminate No. | | | | | | | |
|---|---|---|---|---|---|---|---|---|---|
| Sealing Temp. | | CE1 | E8 | E9 | E10 | E11 | E12 | CE2 | E13 |
| 60° C. | Heat sealing strength* | unable to heat seal | 16.6 | 22.1 | 17.0 | 20.0 | 15.4 | — | 14.9 |
| | Appearance | — | ◯ | ◯ | ◯ | ◯ | ◯ | — | ◯ |
| 70° C. | Heat sealing strength* | 0.07 | 20.5 | 21.1 | 21.0 | 30.4 | 18.4 | — | 17.1 |
| | Appearance | ◯ | ◯ | ◯ | ◯ | ◯ | ◯ | | ◯ |
| 80° C. | Heat sealing strength* | 3.9 | — | 23.0 | 20.7 | 30.5 | 23.7 | — | — |
| | Appearance | ◯ | — | ◯ | ◯ | ◯ | ◯ | — | — |
| 90° C. | Heat sealing strength* | 15.6 | — | — | — | 19.8 | 19.7 | 10.5 | — |
| | Appearance | ◯ | — | — | — | ◯ | ◯ | X | — |

*Heat sealing strength is in unit of N/15 mm.

From the results shown in Table 2, the following are evident.

The laminates of E8-E12 were heat sealable at a temperature ranging from 60° C. to 90° C. and resulted in excellent heat seal strength (ca. 15-30 N/15 mm). In contrast, the laminate of CE1 was unable to be heat sealed at 60° C. When raising the heat sealing temperature up to 70° C. or 80° C., the heat sealed laminates of CE1 provided with insufficient heat sealing strength (i.e. less than 7 N/15mm). Not until the laminate of CE1 was heat sealed at 90° C., a good heat seal strength of 15.6 N/15 mm was obtained. However, even at 90° C., which is not the best heat sealing temperature for the laminate of the present invention, the present laminates of E11 and E12 still provided a heat sealing strength 26% higher than that of the laminate of CE1.

In E13, where the film used as the heat sealable layer (B) was produced from the PTT-PTS copolymers of E5 and a PLA film was used as the structural layer (A). The laminates of E13 were heat sealable at low temperatures (i.e. 60° C. and 70° C.) so that the outer PLA film did not get corrugated because of the sealing heat emitted during heat sealing.

On the contrary, the laminates of CE2, having a known biodegradable polyester film (e.g., Ecoflex®) as the heat sealable layer (B), was heat sealable at a relatively higher temperature (i.e. 90° C.) and resulted in a lower heat sealing strength and also a poor appearance of the outer PLA film after heat sealing.

In summary, the present laminate comprises a low temperature heat sealable layer, that makes it excellent for packaging heat sensitive foodstuffs such as cheese, chocolate, ice-cream, etc. The heat sealable layer of the present laminates can be heat sealed at a temperature below 100° C. with sealing strength higher than the strength requirement. Known biodegradable polymers that may be sensitive to high heat sealing temperature are now suitable for use as the structural layer of the present invention to provide total biodegradable packages that not only have functionally high heat sealing strength but also aesthetically good appearance.

In one embodiment, in the laminate of the present invention, the heat sealable layer (B) is poly(trimethylene terephthalate-co-succinate) which is consisting of repeating units derived from monomers:

(a) about 100 mol % of 1,3-propanediol;

(b) about 70-95 mol % of succinate, and anhydride, salt or ester thereof; and

(c) about 5-30 mol % of terephthalate, and salt or ester thereof.

While the invention has been illustrated and described in typical embodiments, it is not intended to be limited to the details shown, since various modifications and substitutions are possible without departing from the spirit of the present invention. As such, modifications and equivalents of the invention herein disclosed may occur to persons skilled in the art using no more than routine experimentation, and all such modifications and equivalents are believed to be within the spirit and scope of the invention as defined by the following claims.

What is claimed is:

1. A laminate, comprising:
(A) at least one structural layer; and
(B) a heat sealable layer having a melting temperature below 100° C.;
wherein
the structural layer comprises a paper sheet, an aluminum foil, a polymeric film, a metallized polymeric film, or combinations thereof;
the heat sealable layer comprises polytrimethylene succinate, poly(trimethylene terephthalate-co-succinate) or blends thereof; and
provided that when the structural layer is a polymeric film, then the melting temperature of the polymeric film is above 100° C.

2. The laminate of claim 1, wherein the polytrimethylene succinate is consisting essentially of repeating units derived from monomers comprises:
(a) 100 mol % of 1,3-propanediol; and
(b) 100 mol % of succinate, and anhydride, salt or ester thereof.

3. The laminate of claim 1, wherein the poly(trimethylene terephthalate-co-succinate) is consisting essentially of repeating units derived from monomers comprises:
(a) 100 mol % of 1,3-propanediol;
(b) 65-99 mol % of succinate, and anhydride, salt or ester thereof; and
(c) 1-35 mol % of terephthalate, and salt or ester thereof.

4. The laminate of claim 1, wherein the polytrimethylene succinate or the poly(trimethylene terephthalate-co-succinate) has a number average molecular weight of from 12,000 to 100,000.

5. The laminate of claim 1, wherein the structural layer is a polymeric film selected from the group consisting of polylactic acid, polycaprolactone, poly(3-hydroxybutyrate), poly(3-hydroxyvalerate), poly(3-hydroxybutyrate-co-3-hydroxyvalerate), polybutylene succinate; polyethylene terephthalate, polybutylene terephthalate, polyethylene naphthalate, polyamide 6, polyamide 66, poly(m-xylene adipamide), polypropylene, polyethylene, maleic anhydride grafted polyethylene, maleic anhydride grafted polypropylene, ethylene-vinyl acetate copolymer, ethylene-(meth)acrylic acid copolymer, partially neutralized ethylene-(meth)acrylic acid copolymer, ethylene-vinyl alcohol copolymer; polyvinyl alcohol, polyvinyl chloride, polyvinylidene chloride, polychlorotrifluoroethylene, and blends thereof.

6. The laminate of claim 1, wherein the structural layer is a metallized polymeric film selected from aluminized polyethylene terephthalate and aluminized polypropylene.

7. The laminate of claim 1, wherein the total thickness of the structural layer is 5 μm to 200 μm, and the thickness of the heat sealable layer is 5 μm to 100 μm.

8. The laminate of claim 1, wherein the laminate is produced by a method selected from dry lamination, extrusion lamination, extrusion coating, co-extrusion casting, and co-extrusion film blowing.

9. The laminate of claim 1, wherein the laminate further comprises an adhesive layer that is between the structural layer and the heat sealable layer, wherein the adhesive layer comprises or is produced from polyurethane, epoxy, polyacrylate, or mixtures thereof.

10. The laminate of claim 1, wherein the laminate further comprises a tie layer that is between the structural layer and the heat sealable layer, wherein the tie layer comprises or is produced from ethylene-vinyl acetate copolymer, maleic anhydride grafted polyethylene/polypropylene, ethylene-(meth)acrylic acid copolymers, partially neutralized ethylene-(meth)acrylic acid copolymers, or blends thereof.

11. A package comprising the laminate of claim 1, wherein the heat sealable layer is the innermost layer of the package, and the package is heat sealable at a heat sealing temperature below 100° C. to provide a heat sealing strength of 10 N/15 mm or higher as measured according to the method of ASTM F88/F88M-09.

12. The package of claim 11 is a bag, a pouch, a cup lid, or a tray cover.

13. The package of claim 11 further comprising a contained foodstuff.

14. The package of claim 13, wherein the contained foodstuff is cheese, chocolate, or ice-cream.
